(19) United States
(12) Patent Application Publication
(10) Pub. No.: US 2026/0178048 A1
(43) Pub. Date: Jun. 25, 2026

(54) DEEP LEARNING-BASED METHOD FOR RECOGNIZING CONTINUOUS SHOVEL LOADING POSITIONS IN AUTONOMOUS LOADER

(71) Applicants: Guangxi University of Science and Technology, Liuzhou (CN); Guangxi Liugong Machinery Co., Ltd, Liuzhou (CN)

(72) Inventors: Bing LI, Liuzhou (CN); Dengsheng CAI, Liuzhou (CN); Wubin XU, Liuzhou (CN); Jinquan SUN, Liuzhou (CN); Youping SUN, Liuzhou (CN); Xin HE, Liuzhou (CN)

(73) Assignees: Guangxi University of Science and Technology, Liuzhou (CN); Guangxi Liugong Machinery Co., Ltd, Liuzhou (CN)

(21) Appl. No.: 19/428,366

(22) Filed: Dec. 22, 2025

(30) Foreign Application Priority Data
Dec. 23, 2024 (CN) 202411895914.9

(51) Int. Cl. G05D 1/648; B65G 65/00; G01S 7/48; G01S 17/89; G05D 1/242

(52) U.S. Cl. CPC G05D 1/6484; B65G 65/005; G01S 7/4802; G01S 17/89; G05D 1/242

(57) ABSTRACT

A deep learning-based method for recognizing continuous shovel loading positions in an autonomous loader includes: acquiring laser point cloud data representing surface topography of a stockpile, and processing the laser point cloud data to obtain shovel-loading region features of the stockpile; constructing a model of an actuating mechanism for a loader, performing simulation force analysis on the model of the actuating mechanism and the shovel-loading region features of the stockpile, to obtain shovel-loading position features of the stockpile; analyzing and evaluating the shovel-loading position features of the stockpile to obtain an optimal shovel-loading position feature of the stockpile; and constructing a detection model, acquiring an image of the stockpile to be identified simultaneously, inputting the image of the stockpile to be identified into the detection model for processing, and detecting and adjusting a shovel-loading position of the loader based on the image processing results and the optimal shovel-loading position feature.

### CROSS REFERENCE TO THE RELATED APPLICATIONS

This application is based upon and claims priority to Chinese Patent Application No. 202411895914.9, filed on Dec. 23, 2024, the entire contents of which are incorporated herein by reference.

### TECHNICAL FIELD

The present invention relates to the technical field of image processing, and specifically relates to a deep learning-based method for recognizing continuous shovel loading positions in an autonomous loader.

### BACKGROUND

Currently, loaders are widely used in construction sites, mining fields, and other similar environments, serving as essential equipment in modern construction and engineering applications. At present, most loaders still rely on manual operation for shovel-loading tasks, and numerous operational challenges exist throughout the entire loading process: 1) The working environment of loaders is relatively complex, which may pose potential safety hazards to operators; 2) the shovel-loading operation entirely depends on the operator's experience for judgment without unified standards, which substantially affects project efficiency and quality. In order to improve the operational efficiency of loaders, the autonomous operation of loaders has become an important research topic. Shovel-position determination, as the first step in the loading operation process, has critical importance, where accurate positioning ensures effective material collection and bucket filling by the loader. Furthermore, the present system ensures operational safety during loading by: (i) preventing material collapse during shovel engagement, and (ii) eliminating wheel lift incidents caused by excessive digging resistance-thereby maintaining continuous ground contact of all drive wheels throughout the loading cycle. Furthermore, the present invention may ensure the safety of loading operations by preventing collapse during shovel loading and avoiding incidents such as rear wheel lift-off caused by excessive shovel penetration resistance.

However, conventional methods/systems for determining optimal shovel loading positions in the prior art exhibit the following limitations: 1) most prior art methods for selecting shovel loading positions are confined to investigating initial excavation positions of regularly-shaped stockpiles. Prior art methods fail to account for the highly irregular surface topography of stockpiles and non-uniform ground contact edges during continuous loading operations; 2) the efficiency of loader excavation operations is influenced by multiple factors related to shovel positioning, necessitating comprehensive multi-factor consideration; and 3) in practical operating environments, dust generation is inevitable, which significantly attenuates LiDAR signals and causes substantial data loss.

Therefore, how to provide an autonomous loader continuous shovel-loading position recognition method capable of solving the aforementioned problems has become an urgent problem to be solved by those skilled in the art.

### SUMMARY

In view of the foregoing, the present invention provides a deep learning-based method for recognizing continuous shovel loading positions in an autonomous loader, which is capable of reducing the model's parameter count and computational complexity while maintaining detection accuracy.

To achieve the above objective, the present invention adopts the following technical solution.

A deep learning-based method for recognizing continuous shovel loading positions in an autonomous loader, including:
acquiring laser point cloud data representing surface topography of a stockpile, and processing the laser point cloud data to obtain corresponding multiple shovel-loading region features of the stockpile;
constructing a model of an actuating mechanism for a loader, performing a simulation force analysis on the model of the actuating mechanism and the shovel-loading region features of the stockpile, to obtain corresponding shovel-loading position features of the stockpile;
analyzing and evaluating the shovel-loading position features of the stockpile, to obtain an optimal shovel-loading position feature of the stockpile; and
constructing a detection model, acquiring an image of the stockpile to be identified simultaneously, inputting the acquired image of the stockpile to be identified into the detection model for processing, and detecting and adjusting a shovel-loading position of the loader based on the image processing results and the optimal shovel-loading position feature

Preferably, a specific process for obtaining corresponding multiple shovel-loading region features of the stockpile includes:
acquiring laser point cloud data representing surface topography of the stockpile, and preprocessing the laser point cloud data; and
segmenting the preprocessed laser point cloud data, to obtain a convex region feature and a concave region feature of the stockpile, wherein the convex region feature and the concave region feature define shovel-loading region features of the stockpile.

Preferably, a specific process for obtaining the optimal shovel-loading position feature of the stockpile includes:
inputting the model of the actuating mechanism into a simulation software;
performing simulation processing on the model of the actuating mechanism, the convex region feature, and the concave region feature while simultaneously analyzing forces exerted by the material on lateral surfaces of the model of the actuating mechanism;
comparing the forces exerted on the lateral surfaces of the model of the actuating mechanism, selecting a position feature with minimal force as an optimal shovel-loading position feature, namely the convex region feature; and
analyzing the convex region feature to obtain the optimal shovel-loading position feature.

Preferably, a specific process for analyzing the convex region feature to obtain the optimal shovel-loading position feature includes:
obtaining multiple edge-convex regions included in the convex region feature;
calculating, in the simulation software, an edge curvature for each edge-convex region, and computing a maximum insertion resistance, a maximum lifting resistance, and a maximum filling mass for each edge-convex region;
normalizing the maximum insertion resistance, the maximum lifting resistance, and the maximum filling mass;
calculating, by a spider chart assessment method, a degree value formed by each edge-convex region on each axis of the spider chart; and
determining the optimal shovel-loading position feature by comprehensively comparing multiple degree values.

Preferably, a specific process for constructing the detection model includes:
constructing the detection model, wherein the detection model is a Yolov5s model, and modifying the Yolov5s model.

Preferably, a specific process for modifying the Yolov5s model includes:
replacing a backbone network of the Yolov5s model with an improved GhostNet network, introducing a receptive field block (RFB) module into the GhostNet network; adding a convolutional block attention module (CBAM), and selecting an efficient intersection over union (EIOU) function as a loss function.

Preferably, the specific process for constructing the detection model further includes:
constructing an image training dataset of the stockpile, and training the detection model using the image training dataset of the stockpile.

As evidenced by the foregoing technical solution, compared with the prior art, the present invention provides a deep learning-based method for recognizing continuous shovel loading positions in an autonomous loader, which primarily includes three components:
Simulation analysis of shovel loading position features: the influence of concave-convex features on position selection is analyzed based on two-dimensional features, a relevant mathematical model and discrete element simulation are established, and the impact of concave-convex features on shovel loading position selection is analyzed to optimize the shovel loading position;
After preliminarily determining the feature shape of the loading position, the method for distinguishing different feature regions and determining the shovel loading position is by simulating the influence of stockpiles with different edge curvature magnitudes on a loading process. A comprehensive evaluation method is conducted to reflect the performance characteristics of loading operations at different positions, whereby the determination of an optimal loading position is facilitated, thereby enhancing loading efficiency and safety; and
Upon completion of the analysis and identification of loading position features, a series of lightweight improvement measures is implemented to facilitate the deployment of the network model on mobile devices, which is capable of reducing the model's parameter count and computational load while maintaining detection accuracy, thereby reducing operational costs and thus advancing the intelligent development of shovel operations of the autonomous loader.

### BRIEF DESCRIPTION OF THE DRAWINGS

In order to describe the technical solutions in the embodiments of the present disclosure more clearly, the accompanying drawings required to describe the embodiments are briefly described below. Apparently, the accompanying drawings described below are only some embodiments of the present disclosure. Those of ordinary skill in the art may further obtain other accompanying drawings based on these accompanying drawings without creative efforts.

FIG. 1 is an overall flowchart illustrating a deep learning-based method for recognizing continuous shovel loading positions in an autonomous loader according to the present invention;

FIG. 2 is a schematic diagram illustrating simulated point cloud acquisition for excavation positions according to an embodiment of the present invention, wherein 1. support frame; 2. planar solid-state lidar array; 3. stockpile;

FIGS. 3A-3B are schematic diagrams illustrating a point cloud segmentation result according to an embodiment of the present invention, wherein FIG. 3A is a schematic diagram of a 3D modeling of raw data, and FIG. 3B is a schematic diagram illustrating the point cloud segmentation result;

FIG. 4 is a schematic diagram illustrating a simulation of a convex portion of loaded crushed stones according to an embodiment of the present invention;

FIG. 5 is a schematic diagram illustrating a simulation of a concave portion of loaded crushed stones according to an embodiment of the present invention;

FIG. 6 is a schematic diagram illustrating axial/lateral forces exerted on a bucket by concave/convex portions of crushed stones according to an embodiment of the present invention;

FIG. 7 is a schematic diagram showing the accumulation morphology of crushed stones after completing the loading operation according to an embodiment of the present invention;

FIGS. 8A-8B are schematic diagrams illustrating a simulation of crushed stone pile generation with different buckets according to an embodiment of the present invention;

FIG. 9A is a schematic diagram illustrating a Roberts operator template according to an embodiment of the present invention;

FIG. 9B is a schematic diagram illustrating a Roberts operator according to an embodiment of the present invention;

FIG. 10 is a schematic diagram comparing three edge curvature profiles of 3,375 kg material batches generated according to an embodiment of the present invention;

FIG. 11 is a schematic diagram comparing three edge curvature profiles of 5,063 kg material batches generated according to an embodiment of the present invention;

FIG. 12 is a schematic diagram comparing three edge curvature profiles of 6,750 kg material batches generated according to an embodiment of the present invention;

FIG. 13 is a spider chart illustrating evaluation and comparison results according to an embodiment of the present invention;

FIG. 14 is a schematic diagram illustrating an improved YOLOv5s network model according to an embodiment of the present invention;

FIG. 15 is a schematic diagram of a receptive field block (RFB) module according to an embodiment of the present invention; and

FIG. 16 is a schematic diagram of a convolutional block attention module (CBAM) according to an embodiment of the present invention.

### DETAILED DESCRIPTION OF THE EMBODIMENTS

In the following, the technical solution in the embodiment of the disclosure will be clearly and completely described in combination with the attached drawings in the embodiment of the present invention. Apparently, the described embodiment is only a part of the embodiment of the present invention, but not all of the embodiment. Based on the embodiments in the present invention, all other embodiments obtained by those of ordinary skill in the art without creative efforts belong to the scope of protection in the present invention.

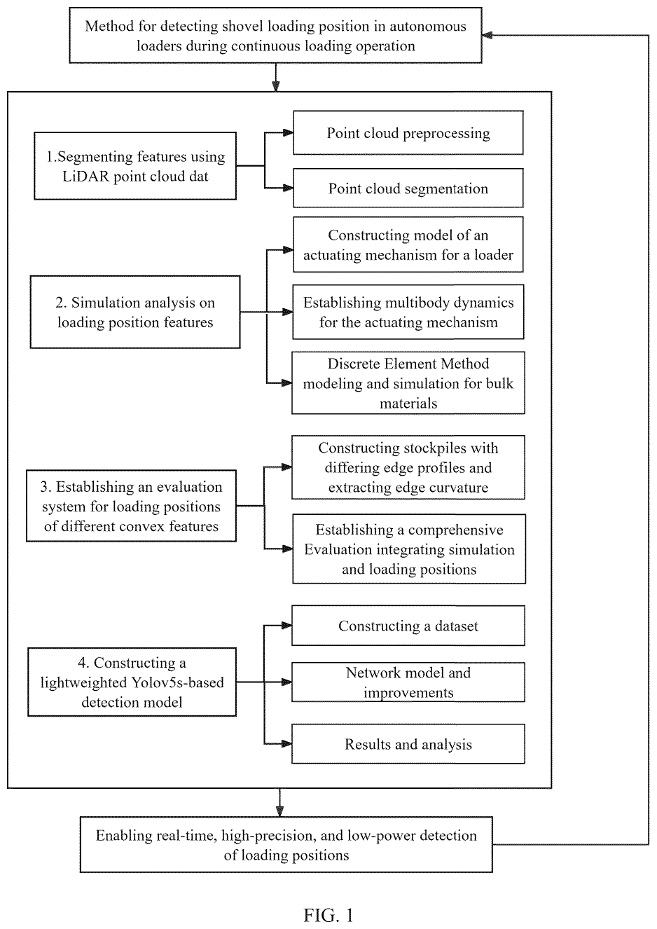

As shown in FIG. 1, an embodiment of the present invention discloses a deep learning-based method for recognizing continuous shovel loading positions in an autonomous loader, including:
laser point cloud data representing surface topography of a stockpile is acquired, and the laser point cloud data is processed to obtain corresponding multiple shovel-loading region features of the stockpile;
a model of an actuating mechanism for a loader is constructed, a simulation force analysis is performed on the model of the actuating mechanism and the shovel-loading region features of the stockpile, to obtain corresponding shovel-loading position features of the stockpile, wherein the actuating mechanism of the loader takes a 1.2-ton loader as the research object, and the material simulation model of the stockpile takes gravel as the research object;
the shovel-loading position features of the stockpile is analyzed and evaluated, to obtain an optimal shovel-loading position feature of the stockpile; and
constructing a detection model is constructed, an image of the stockpile to be identified is acquired simultaneously, the acquired image of the stockpile to be identified is input into the detection model for processing, and a shovel-loading position of the loader is detected and adjusted based on the image processing results and the optimal shovel-loading position feature.

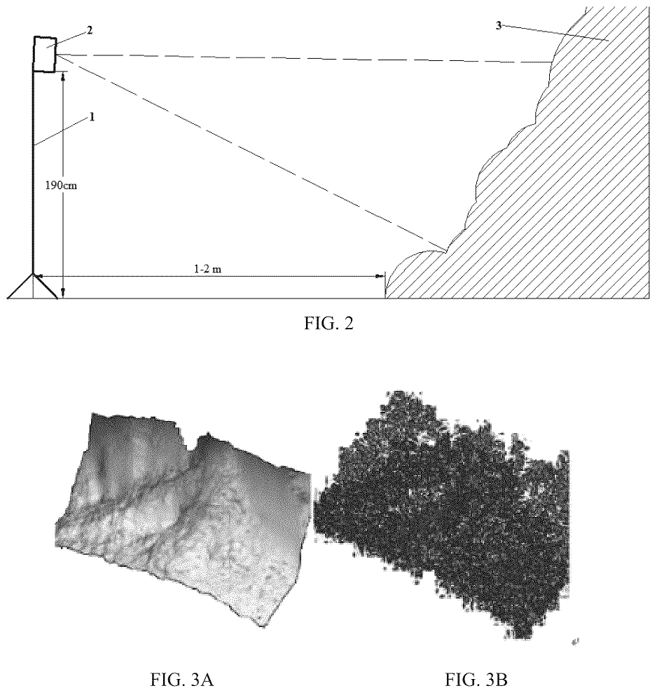

In a specific embodiment, as shown in FIGS. 2-3B, a specific process for obtaining corresponding multiple shovel-loading region features of the stockpile includes:
acquiring laser point cloud data representing surface topography of the stockpile is acquired, and the laser point cloud data is preprocessed; and
the preprocessed laser point cloud data is segmented, to obtain a convex region feature and a concave region feature of the stockpile, wherein the convex region feature and the concave region feature define shovel-loading region features of the stockpile.

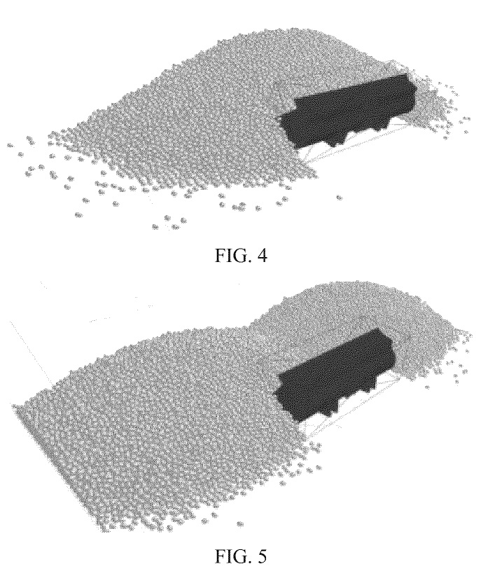

As shown in FIGS. 4-5, in a specific embodiment, a specific process for obtaining the optimal shovel-loading position feature of the stockpile includes:
the model of the actuating mechanism is input into a simulation software, wherein the simulation software may be an Element Discrete Element Method (EDEM);
simulation processing is performed on the model of the actuating mechanism, the convex region feature, and the concave region feature while simultaneously analyzing forces exerted by the material on lateral surfaces of the model of the actuating mechanism;
the forces exerted on the lateral surfaces of the model of the actuating mechanism are compared, and a position feature with minimal force is selected as an optimal shovel-loading position feature, namely the convex region feature; and
the convex region feature is analyzed to obtain the optimal shovel-loading position feature

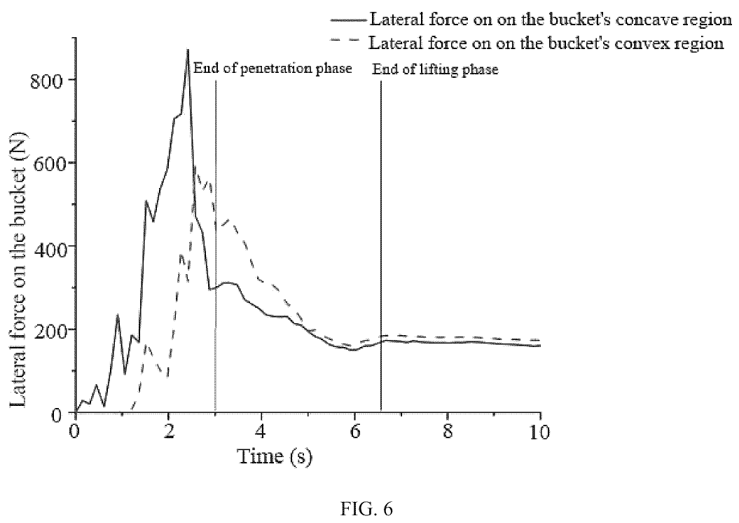

Specifically, the force exerted by the material on the lateral surfaces of a loader bucket is determined via post-processing in EDEM software, with the specific results shown in FIG. 6, wherein:
the period of 0-3 seconds corresponds to a penetration phase;
the period of 3-6 seconds corresponds to a lifting phase; and
the period after 6 seconds corresponds to the bucket retraction phase.

As can be seen from FIG. 6, during the material penetration phase, the convex region of the loader bucket is subjected to a substantially lower lateral force along the X-axis compared to the concave region. During a loading operation, particularly when the loader engages with an irregular material surface, the loader may experience including but not limited to increased resistance, wheel slippage, and a decrease in engine speed. According to the “Technical Operating Safety Regulations for Loaders”, the loading operation should be ceased immediately upon encountering such conditions, as continued forced operation may result in a loss of balance and potential tipping of the loader. Therefore, the convex region feature effectively prevents the loader bucket from being subjected to excessive lateral forces during shovel-loading operations, and serves as a feature shape for determining the optimal loading position, which ensures operational safety during the loading process and furthermore establishes a foundation for subsequent evaluation and differentiation of multiple distinct protrusion features within the stockpile.

In a specific embodiment, a specific process for analyzing the convex region feature to obtain the optimal shovel-loading position feature of the stockpile includes:
multiple edge-convex regions included in the convex region feature are obtained;
in the simulation software, an edge curvature for each edge-convex region is calculated, and a maximum insertion resistance, a maximum lifting resistance, and a maximum filling mass for each edge-convex region are computed;
the maximum insertion resistance, the maximum lifting resistance, and the maximum filling mass are normalized;
by a spider chart assessment method, a degree value formed by each edge-convex region on each axis of the spider chart is calculated; and
the optimal shovel-loading position feature of the stockpile is determined by comprehensively comparing multiple degree values.

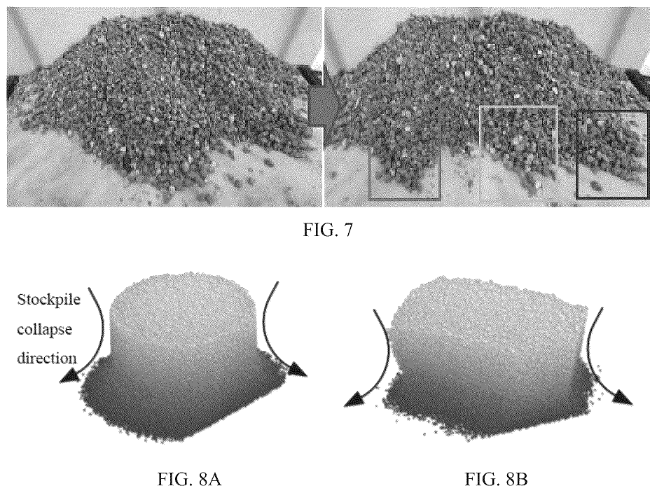

Specifically, after the preliminary determination of the feature shape of the loading position, It can be observed that the area excavated by the loader bucket exhibits a profile that is concave in the central portion and convex on both sides, as shown in FIG. 7. Based on the situation, it can be determined that the subsequent loading position should be selected on a convex region, as denoted by the three regions outlined by different colored boxes in FIG. 7. Therefore, distinguishing different convex regions is critical for the selection of the loading position and constitutes a key step in ensuring energy efficiency and high productivity of the loader in industrial operations. In the embodiment of the present invention, an image recognition method is employed, utilizing image features of different convex regions as the basis for identification. As can be seen from FIGS. 8A-8B, the degree of curvature at the edges of the convex regions varies; the specific process for calculating the edge curvature is as follows:

A cylindrical container and a rectangular container, each with a cross-sectional area of 2.54 m², are established and filled with gravel particles weighing 3,375 kg, 5,063 kg, and 6,750 kg, respectively. The particle generation process is shown in FIGS. 8A-8B. The stockpile with varying edge profiles is obtained by elevating the cylindrical container;

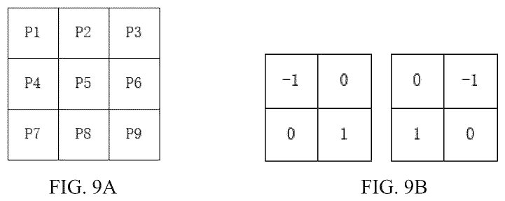

The accumulated image is binarized processing from a top-view perspective in Matlab to obtain an edge shape, and then the pixel coordinate points of the edge contour curve are extracted utilizing the Roberts edge detection method;
the Roberts operator is effectively employed for detecting the rugged edges of the stockpile under low-noise conditions, and the estimation of potentially existing edges in an image is primarily achieved through the calculation of differences between diagonally adjacent pixels. For example, exemplary kernels of the operator are shown in FIG. 9A and FIG. 9B. The specific formulas for calculating the gradient magnitudes gₓ and g_{y} in the X and Y directions at pixel point P₂ are as follows:

$${g}_{x} = \frac{\partial f}{\partial x} = P 6 - P 2 \qquad ( 1 )$$

$${g}_{y} = \frac{\partial f}{\partial y} = P 5 - P 3 \qquad ( 2 )$$

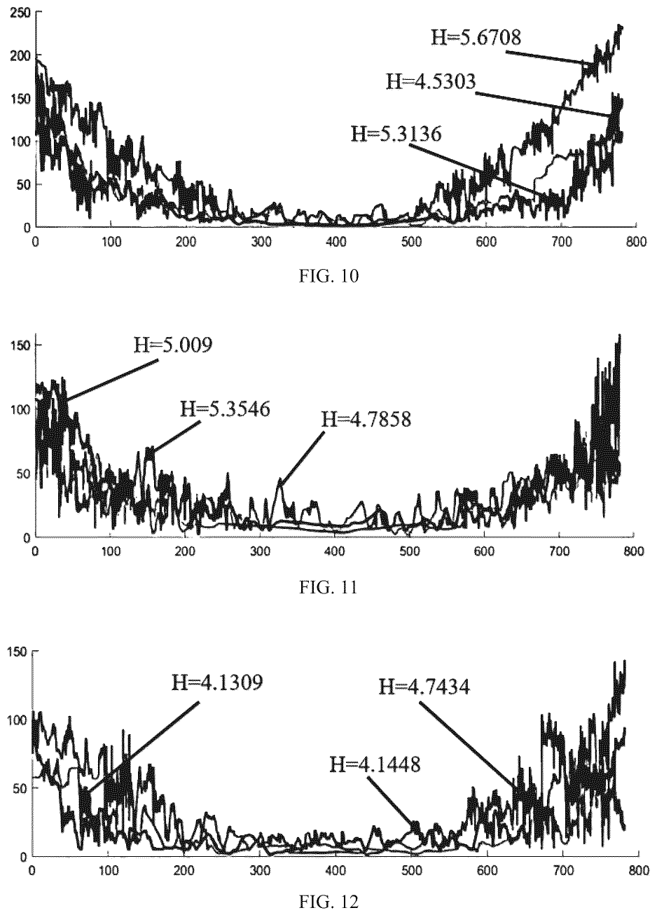

The curve is fitted, and the average curvature value is calculated using Formula (4) as shown below. The equation of the curve is given by Formula (3), from which the curvature matrix K is derived using parametric derivative method, whereby the mean curvature His subsequently obtained by dividing the matrix K by the number of points. In the EDEM software, stockpiles with nine different edge curvatures are generated through the simulation of three different masses of gravel particles within three distinct discharge containers, respectively, and the extracted edge curvatures are shown in FIGS. 10-12.

$$\{ \begin{matrix}x = φ ( t ) \\ y = ω ( t )\end{matrix} \qquad ( 3 )$$

$$H = \frac{\vert {φ}^{′} ( t ) {ω}^{″} ( t ) - {ω}^{′} ( t ) {φ}^{″} ( t ) \vert}{{[ {φ}^{′ 2} ( t ) + {ω}^{′ 2} ( t ) ]}^{\frac{3}{2}} \times N} \qquad ( 4 )$$

The numerical values of maximum insertion resistance, maximum lifting resistance, and maximum filling mass are directly obtained through coupled EDEM and Adams simulations for the stockpiles with nine different edge curvatures, and are used as three indicators for evaluating the advantages and disadvantages of distinct convex region locations;

Then numerical values of maximum insertion resistance, maximum lifting resistance, and maximum filling mass are directly obtained through coupled EDEM and Adams simulations for the stockpiles with nine different edge curvatures, and are used as three indicators for evaluating the advantages and disadvantages of distinct convex region locations. Due to differences in measurement units and scales among the three indicators, which adversely affect modeling and analysis results, the data needs to be normalized so that the data is mapped to a range of (0-1), thereby enabling comparability between different features. The min-max normalization is performed according to Formula (5):

$${X}_{s c a l e} = \frac{x - {x}_{min}}{{x}_{max} - {x}_{min}} \qquad ( 5 )$$

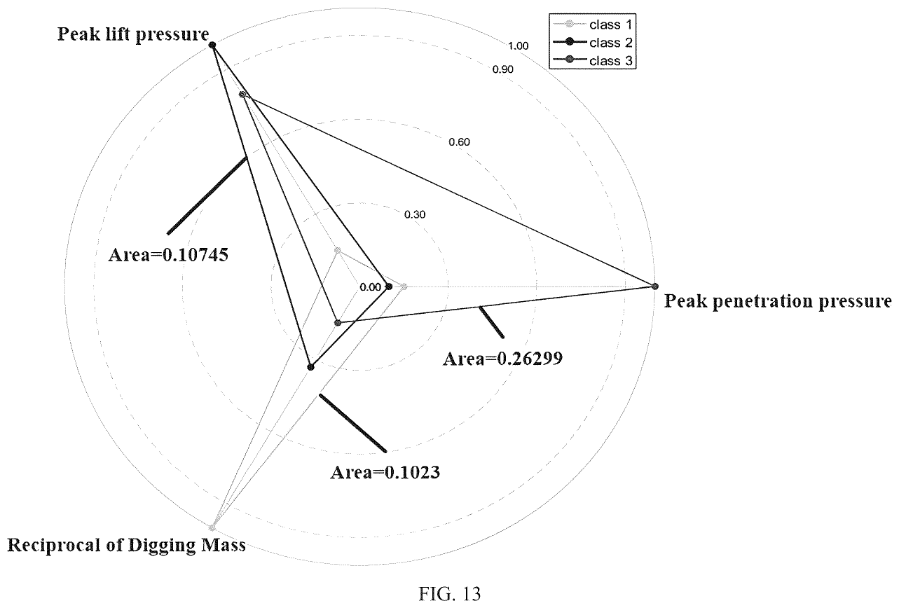

During the post-processing in EDEM based on the loading process conditions, the insertion phase and the lifting phase of the loader bucket are selected. The maximum pressure values in the respective directions of the above phases and the mass of the excavated material are used as three indicators for evaluating the performance of different loading positions. Subsequently, a spider chart evaluation method is utilized to calculate corresponding performance scores. Finally, the performance level is reflected by comparing the magnitudes of the scores, as illustrated in FIG. 13

In a specific embodiment, a specific process for constructing the detection model includes:
the detection model is constructed, wherein the detection model is a Yolov5s model, and the Yolov5s model is modified.

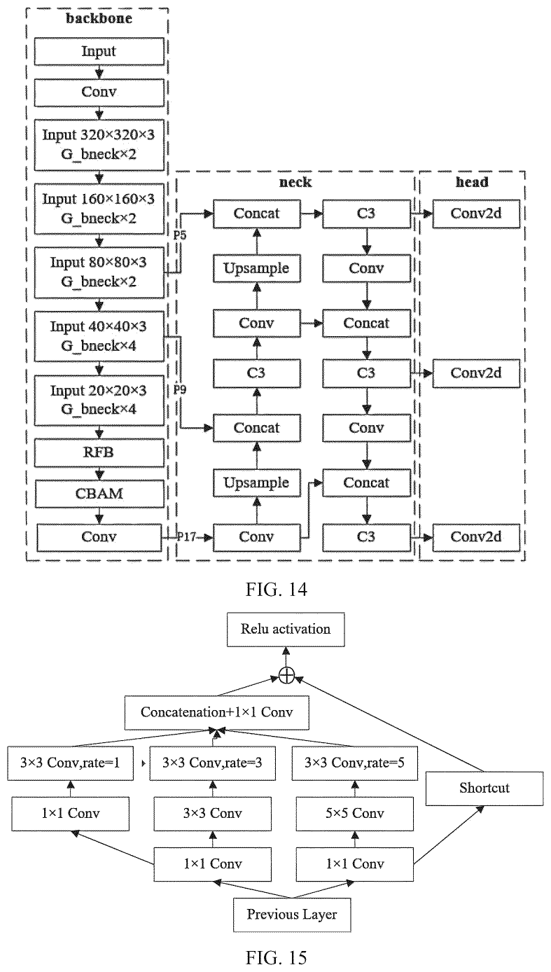

As shown in FIG. 14, in a specific embodiment, a specific process for modifying the Yolov5s model includes:
a backbone network of the Yolov5s model is replaced with an improved GhostNet network, a receptive field block (RFB) module is introduced into the GhostNet network; a convolutional block attention module (CBAM) is added, and an efficient intersection over union (EIOU) function is selected as a loss function.

Specifically, the specific process for modifying the Yolov5s model is as follows:

The Backbone Network is Replaced with a GhostNet Network

GhostNet is specifically designed to enhance computational efficiency. Compared with conventional convolutional networks, computational complexity is effectively reduced by introducing Ghost modules in the GhostNet. Consequently, the improved Yolov5s model is capable of operating more fluently than the standard Yolov5s model on mobile devices or embedded systems, thereby facilitating the achievement of real-time object detection, thereby facilitating real-time object detection.

Furthermore, superior performance in terms of parameter count is also demonstrated by GhostNet, wherein a significant reduction in the quantity of model parameters is achieved. The feature not only reduces memory consumption but also significantly decreases the computational resources required for network inference, thereby resulting in an overall more lightweight model, which is of particular significance for resource-constrained devices, especially mobile equipment such as autonomous loaders. Simultaneously, the inference speed of Yolov5s may be enhanced by the efficient feature extraction capability of GhostNet.

The RFB Module is Introduced into the Backbone GhostNet Network

The multi-scale feature extraction capability of the network is enhanced by the RFB module through the use of convolutional operations with varying scales. The receptive field of conventional convolutional layers is limited, whereas multi-scale contextual information is effectively captured by the RFB module through integration of multiple convolution kernel sizes. This multi-scale feature learning is particularly critical for object detection, whereby small objects and objects in complex scenes can be better recognized by the model, thereby resulting in an improvement in overall detection accuracy. The GhostNet network and the RFB module are utilized in combination, whereby a balance between parameter count and computational complexity is achieved while model accuracy is simultaneously enhanced. Particularly when confronting challenges such as object occlusion and complex environments, the detection capability may be significantly enhanced by the combined architecture. Furthermore, due to the lightweight nature of GhostNet and the efficient design of the RFB module, a high accuracy rate is maintained by the overall model while rapid inference is simultaneously achieved, which is particularly crucial for application scenarios requiring real-time feedback, such as during the loading operations of autonomous loaders. The structure of the combined model is illustrated in FIG. 15.

### A Convolutional Block Attention Module (CBAM) is Added

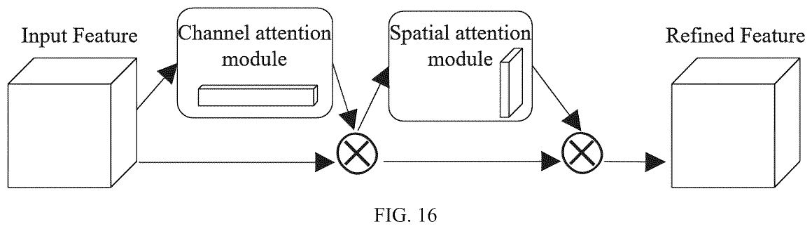

The core concept of the CBAM attention mechanism lies in the introduction of adaptive weighting to both spatial features and channel-wise features within a convolutional neural network. Consequently, the network's capability to effectively extract key information from input data, upon which greater emphasis is placed, is enhanced. The CBAM primarily includes two constituent components, wherein the channel attention mechanism calculates global statistical measures for activation maps of each channel, then channel-wise weighting coefficients are generated via normalization operations applied to the statistical measures, the original feature maps are recalibrated by applying the weighting coefficients, thereby emphasizing channel features of higher significance; the spatial attention mechanism derives a global spatial significance distribution through sequential convolution and pooling operations, subsequently generating position-specific weighting coefficients indicative of regional importance within input imagery. Finally, the respective weighting coefficients are combined by element-wise multiplication to recalibrate the spatial dimensions of the original feature maps, the structural configuration is shown in FIG. 16.

In a specific embodiment, the specific process for constructing the detection model further includes:
a bulk material image training dataset is constructed, and the constructed training dataset is utilized for training the detection model.

Specifically, during construction of the bulk material image training dataset, diverse transformations are introduced to expose the model to data under varying perspectives and conditions, thereby enabling the acquisition of more generalized feature representations. In an embodiment of the present invention, data augmentation is implemented, resulting in a finalized training dataset including 2,400 bulk material images at a resolution of 7,296×5,472 pixels being obtained after augmentation processing

During the selection of a loss function, the original CIOU loss function adopted by the model is identified to exhibit the following technical deficiencies: when an aspect ratio of a predicted bounding box is identical to that of a ground truth bounding box, the aspect ratio penalty term is reduced to zero, consequently causing regression optimization stagnation.

Therefore, in an embodiment of the present invention, the original loss function is replaced with an Enhanced Intersection over Union (EIOU) loss function. Based on the penalty term of CIOU, EIOU decouples the impact factor of the aspect ratio between the predicted bounding box and the ground truth bounding box, and separately computes the differences in height and width, thereby addressing the issues of CIOU. The mathematical formulation of the EIoU loss function is presented in Formula (6):

$${L}_{EIoU} = 1 - IoU + \frac{{ρ}^{2} ( {A}_{ctr} , {B}_{ctr} )}{{c}^{2}} + \frac{{ρ}^{2} ( ω , {ω}^{gt} )}{{c}_{ω}^{2}} + \frac{{ρ}^{2} ( h , {g}^{gt} )}{{c}_{h}^{2}} \qquad ( 6 )$$

Wherein, ρ denotes the Euclidean distance between the centroid of predicted bounding box A and the centroid of target bounding box B, A_{ctr} and B_{ctr} denote the centroid coordinates of predicted bounding box A and target bounding box B, respectively, c denotes the Euclidean length of the diagonal of the minimum closed bounding box enclosing both predicted bounding box A and target bounding box B, ω^{gt} and h^{gt} denote the width and height of the target bounding box, respectively, ω and h denote the width and height of the predicted bounding box, respectively; C_{ω} and Cₕ represent the width and height of the minimum closed bounding box enclosing both bounding boxes; and IoU denotes the Intersection over Union between the predicted bounding box and the target bounding box.

Each embodiment in the description is described in a progressive manner, and each embodiment focuses on its differences from other embodiments, the same and similar parts of each embodiment can be referred to each other. For the device disclosed by the embodiment, the description is relatively simple because it corresponds to the method disclosed by the embodiment, and the relevant information can be referred to the method section.

The above description of the disclosed embodiments enables those skilled in the art to implement or use the present disclosure. Various amendments to the embodiments will be apparent to those skilled in the art. The general principles defined herein may be implemented in other embodiments without departing from the spirit or scope of the disclosure. Therefore, the present disclosure will not be limited to the embodiments shown herein but is to be accorded the widest scope consistent with the principles and novel features disclosed herein.

What is claimed is:

1. A deep learning-based method for recognizing continuous shovel loading positions in an autonomous loader, comprising:
acquiring laser point cloud data representing surface topography of a stockpile, and processing the laser point cloud data to obtain a plurality of shovel-loading region features of the stockpile;
constructing a model of an actuating mechanism for a loader, performing a simulation force analysis on the model of the actuating mechanism and the plurality of shovel-loading region features of the stockpile, to obtain shovel-loading position features of the stockpile;
analyzing and evaluating the shovel-loading position features of the stockpile, to obtain an optimal shovel-loading position feature of the stockpile; and
constructing a detection model, acquiring an image of the stockpile to be identified simultaneously, inputting the image of the stockpile to be identified into the detection model for processing to obtain image processing results, and detecting and adjusting a shovel-loading position of the loader based on the image processing results and the optimal shovel-loading position feature.

2. The deep learning-based method for recognizing the continuous shovel loading positions in the autonomous loader according to claim 1, wherein a process for obtaining the plurality of shovel-loading region features of the stockpile comprises:
acquiring the laser point cloud data representing the surface topography of the stockpile, and preprocessing the laser point cloud data to obtain preprocessed laser point cloud data; and
segmenting the preprocessed laser point cloud data to obtain a convex region feature and a concave region feature of the stockpile, wherein the convex region feature and the concave region feature define the plurality of shovel-loading region features of the stockpile.

3. The deep learning-based method for recognizing the continuous shovel loading positions in the autonomous loader according to claim 2, wherein a process for obtaining the optimal shovel-loading position feature of the stockpile comprises:
inputting the model of the actuating mechanism into a simulation software;
performing simulation processing on the model of the actuating mechanism, the convex region feature, and the concave region feature while simultaneously analyzing forces exerted by a material on lateral surfaces of the model of the actuating mechanism;
comparing the forces exerted on the lateral surfaces of the model of the actuating mechanism, and selecting a position feature with a minimal force as the convex region feature; and
analyzing the convex region feature to obtain the optimal shovel-loading position feature.

4. The deep learning-based method for recognizing the continuous shovel loading positions in the autonomous loader according to claim 3, wherein a process for analyzing the convex region feature to obtain the optimal shovel-loading position feature comprises:
obtaining a plurality of edge-convex regions comprised in the convex region feature;
calculating, in the simulation software, an edge curvature for each of the plurality of edge-convex regions, and computing a maximum insertion resistance, a maximum lifting resistance, and a maximum filling mass for each of the plurality of edge-convex regions;
normalizing the maximum insertion resistance, the maximum lifting resistance, and the maximum filling mass;
calculating, by a spider chart assessment method, a degree value formed by each of the plurality of edge-convex regions on each axis of a spider chart; and
determining the optimal shovel-loading position feature by comprehensively comparing a plurality of degree values.

5. The deep learning-based method for recognizing the continuous shovel loading positions in the autonomous loader according to claim 1, wherein a process for constructing the detection model comprises:
constructing the detection model, wherein the detection model is a Yolov5s model, and modifying the Yolov5s model.

6. The deep learning-based method for recognizing the continuous shovel loading positions in the autonomous loader according to claim 5, wherein a process for modifying the Yolov5s model comprises:
replacing a backbone network of the Yolov5s model with an improved GhostNet network, and introducing a receptive field block (RFB) module into the improved GhostNet network; and adding a convolutional block attention module (CBAM), and selecting an efficient intersection over union (EIOU) function as a loss function.

7. The deep learning-based method for recognizing the continuous shovel loading positions in the autonomous loader according to claim 5, wherein the process for constructing the detection model further comprises:
constructing an image training dataset of the stockpile, and training the detection model using the image training dataset of the stockpile.
